(19) United States
(12) Patent Application Publication
(10) Pub. No.: US 2024/0208259 A1
(43) Pub. Date: Jun. 27, 2024

(54) FORMATION OF A 3D IMAGE USING A LENTICULAR STRUCTURE

(71) Applicant: IDEMIA FRANCE, Courbevoie (FR)

(72) Inventors: Coralie VANDROUX, Courbevoie (FR); Benoît BERTHE, Courbevoie (FR)

(73) Assignee: IDEMIA FRANCE, Courbevoie (FR)

(21) Appl. No.: 18/544,573

(22) Filed: Dec. 19, 2023

(30) Foreign Application Priority Data
Dec. 22, 2022 (FR) 22 14344

(51) Int. Cl. B42D 25/435; B23K 26/362; G02B 30/27; G03H 1/00

(52) U.S. Cl. CPC B42D 25/435; B23K 26/362; G02B 30/27; G03H 1/0011; B42D 25/328

(57) ABSTRACT

The aim of the invention is to form a 3D image using a lenticular structure comprising: a carrier layer comprising an arrangement of color sub-pixels and a lenticular array comprising convergent lenses facing the sub-pixels. A method of the invention comprises: performing visual inspection of the lenticular structure, during which sub-pixels viewable through the lenses are detected for a plurality of viewing directions; determining, based on the color of the sub-pixels detected for each viewing direction, grayscale levels required to reveal M images viewable through the lenticular array in the M viewing directions, respectively; and customizing the sub-pixel arrangement, during which the grayscale levels are engraved facing the sub-pixels in the carrier layer by focus of laser radiation through the lenses.

### TECHNICAL FIELD

The invention relates to a technique for forming 3-dimensional (3D) grayscale or color images, and more particularly relates to the customization of an arrangement of pixels viewable through a lenticular array to form a 3D image.

### PRIOR ART

The identity market nowadays requires identity documents (also called identification documents) to be increasingly secure. These documents must be easily authenticatable and difficult to counterfeit (if possible unforgeable). This market relates to highly diverse documents, such as identity cards, passports, access badges, driving licenses, etc., which may take various formats (cards, booklets, etc.).

Various types of secure documents comprising images have thus been developed over time, especially with a view to securely identifying people. Passports, identity cards and various other official documents nowadays generally comprise security elements that allow the document to be authenticated and the risks of fraud, falsification or counterfeiting to be limited. Electronic identity documents comprising a chip card, such as electronic passports for example, have thus seen a substantial increase in popularity over the last few years.

Various printing techniques have been developed over the course of time to produce color prints. Production in particular of identity documents such as those mentioned above requires images to be produced securely in order to limit the risks of falsification by malicious individuals. The manufacture of such documents, in particular as regards the image used to identify the holder, needs to be complex enough to make reproduction or falsification by an unauthorized individual difficult.

One known solution thus consists in printing, on a carrier, a matrix array of pixels formed of color sub-pixels and in forming grayscale levels by laser carbonization in a laserable layer located facing the matrix array of pixels, so as to reveal a customized color image that is difficult to falsify or to reproduce. Some examples of embodiments of this technique are described for example in documents EP 2 580 065 B1 (dated Aug. 6, 2014) and EP 2 681 053 B1 (dated Apr. 8, 2015).

Although this known technique offers good results, some improvements are still possible in terms in particular of the quality of the visual rendering of the image as well as the level of security achieved. Specifically, using this image-forming technique it is difficult to achieve high levels of color saturation. In other words, the color gamut (ability to reproduce a range of colors) of this known technique may prove to be limited, which may pose a problem in some use cases. This is due in particular to the fact that the color sub-pixels are formed by a conventional printing method, by “offset” printing for example, which does not make it possible to form sufficiently rectilinear and continuous rows of sub-pixels, thereby leading to uniformity defects when printing the sub-pixels (interruptions in the rows of pixels, irregular outlines, etc.) and degraded colorimetric rendering.

Current printing techniques also offer limited positioning accuracy due to the inaccuracy of printing machines, thereby also reducing the quality of the final image owing to incorrect positioning of the pixels and sub-pixels with respect to one another (problems with overlapping sub-pixels, misalignments, etc.) or owing to the presence of a non-printed tolerance interval between the sub-pixels.

Known holographic imaging methods further allow 3D images (image in 3 dimensions) to be formed, but these techniques are complex and do not always offer a satisfactory visual result.

At the present time, there is therefore a need to reliably form 3D images that are secure and of good quality, in particular but not exclusively in documents such as identity documents, official documents, etc. There is in particular a need to form color or grayscale images such as these that are difficult to falsify or to reproduce, using a manufacturing process that is as simple as possible. A good level of security is desirable while guaranteeing image quality, in terms of resolution, remains good. There is also a need to produce 3D images having a good level of lightness and a high color saturation.

### SUMMARY OF THE INVENTION

In view in particular of the problems and inadequacies mentioned above, the present invention in particular relates to a method for forming a 3D image, using a lenticular structure comprising:
a carrier layer on which is formed an arrangement of sub-pixels of at least two different colors, each sub-pixel having a single color among said at least two different colors; and
a lenticular array comprising convergent lenses placed facing the sub-pixel arrangement;
the method comprising the following steps:
a) performing visual inspection of the lenticular structure, by means of an image-capturing apparatus, said visual inspection comprising the following steps for each among M different viewing directions relative to the lenticular array, M being an integer at least equal to 2:
   a1) positioning the image-capturing apparatus in the viewing direction;
   a2) detecting sub-pixels viewable through the lenses in said viewing direction;
b) determining, based on the color of the sub-pixels detected in a2) for each viewing direction, grayscale levels to be generated to reveal, by way of the arrangement of sub-pixels, M images viewable through the lenticular array in the M viewing directions, respectively; and
c) customizing the sub-pixel arrangement, during which the grayscale levels determined in b) are engraved facing the sub-pixels in the carrier layer by focus of laser radiation through the lenticular array so as to reveal, by way of the sub-pixel arrangement combined with the grayscale levels, the M images viewable through the lenticular array in the M viewing directions, respectively, said M images collectively forming the 3D image.

According to one particular embodiment, said method is implemented by a customizing system comprising the image-capturing apparatus and a laser device placed in the optical train of the image-capturing apparatus, the laser device projecting the laser radiation in customizing step c) in each viewing direction adopted by the image-capturing apparatus in positioning step a1).

According to one particular embodiment, the grayscale levels engraved in customizing step c) intrinsically form with the sub-pixel arrangement an interlacement of image pixels of the M images viewable through the lenticular array by varying the viewing direction among the M viewing directions.

According to one particular embodiment, the M images represent:
various views of the same static object, these various views respectively being viewable in space in the adopted viewing directions through the lenticular array so as to produce a 3D effect; or
various views of the same moving object, the various views being viewable in the adopted viewing directions through the lenticular array so as to produce a 3D animation.

According to one particular embodiment, the sub-pixels are configured so that their respective colors, among said at least two different colors, are periodically distributed in the sub-pixel arrangement.

According to one particular embodiment, the sub-pixel arrangement is formed by either one of the following steps:
d) printing on the carrier; and
e) forming a holographic metal layer.

According to one particular embodiment, the lenses of the lenticular array are hemispherical or aspherical convergent lenses.

According to one particular embodiment, the sub-pixel arrangement is positioned approximately in the focal plane of the lenses of the lenticular array.

According to one particular embodiment, during visual inspection a), the image-capturing apparatus effects an angular and/or translational relative movement to position itself, in a1), in each of the M viewing directions, so as to carry out detecting step a2) for each viewing direction.

According to one particular embodiment, the method comprises storing, in a memory of the customizing system, inspection data characterizing the sub-pixels detected in a2) through the lenticular array for each of the M viewing directions,
said determining step b) being carried out based on the inspection data and on image data representative of the M images forming the 3D image.

According to one particular embodiment, in the customizing step, perforations are produced in the sub-pixel arrangement by said focus of the laser radiation so as to reveal locally, through the sub-pixel arrangement, grayscale levels in the sub-pixels caused by underlying regions of the carrier layer located facing the perforations.

According to one particular embodiment, the carrier layer is opaque at least in the visible spectrum, the perforations formed in the customizing step revealing locally, through the sub-pixel arrangement, dark underlying regions of the carrier layer, said dark underlying regions being located facing the perforations and forming all or some of the grayscale levels facing the sub-pixels.

According to one particular embodiment, the carrier layer comprises an ultraviolet-sensitive ink so that the 3D image is visible when said carrier layer is exposed to ultraviolet, the ink revealed through the perforations forming all or some of the grayscale levels facing the sub-pixels.

According to one particular embodiment, the carrier layer is transparent at least in the visible spectrum, the perforations revealing locally, through the sub-pixel arrangement, light underlying regions of the carrier layer, said light underlying regions being located facing the perforations when incident light in the visible spectrum is projected through the carrier layer, and forming all or some of the grayscale levels facing the sub-pixels.

In one particular embodiment, the various steps of the display method (or at least some of them) are determined by computer program instructions.

Consequently, the invention also relates to a computer program on a data medium (or storage medium), this program being capable of being implemented in a customizing system or more generally in a computer, this program comprising instructions configured to implement the steps of a forming method such as defined above and such as described below in the case of particular embodiments.

This program may use any programming language, and take the form of source code, object code, or code intermediate between source code and object code, such as code in a partially compiled form, or in any other desirable form.

The invention also relates to a computer-readable data medium (or storage medium) comprising instructions of a computer program such as mentioned above.

The data medium may be any entity or device capable of storing the program. For example, the medium may comprise a storage means, such as a rewritable non-volatile memory or ROM, for example a CD ROM or a microelectronic circuit ROM, or even a magnetic storage means, for example a floppy disk or a hard disk.

Furthermore, the data medium may be a transmissible medium such as an electrical or optical signal, which may be delivered via an electrical or optical cable, by radio or by other means. The program according to the invention may in particular be downloaded over an IP network.

Alternatively, the data medium may be an integrated circuit into which the program is incorporated, the circuit being configured to execute or to be used in the execution of the method in question.

The present invention also relates to a customizing system configured to form a 3D image using a lenticular structure such as already defined above. More precisely, the invention provides a customizing system configured to implement the forming method of the invention.

According to one particular embodiment, the invention provides a customizing system for forming a 3D image using a lenticular structure comprising:
a carrier layer on which is formed an arrangement of a plurality of sub-pixels of at least two different colors, each sub-pixel having a single color among said at least two different colors; and
a lenticular array comprising convergent lenses placed facing the sub-pixel arrangement;
the customizing system comprising:
an inspecting unit configured to perform a visual inspection of the lenticular structure by viewing the sub-pixel arrangement through the lenticular array by means of an image-capturing apparatus, said visual inspection comprising the following steps for each among M different viewing directions relative to the lenticular array, M being an integer at least equal to 2:
   a1) positioning the image-capturing apparatus in the viewing direction;
   a2) detecting sub-pixels viewable through the lenses in said viewing direction;
a computing unit configured to determine, from the color of the sub-pixels detected in a2) for each viewing direction, grayscale levels to be generated to reveal, by way of the sub-pixel arrangement, M images viewable through the lenticular array in the M viewing directions, respectively; and
a customizing unit configured to customize the sub-pixel arrangement by forming grayscale levels facing the sub-pixels in the carrier layer by focus of laser radiation through the lenses so as to reveal the M images viewable through the lenticular array in the M viewing directions, respectively, said M images collectively forming the 3D image.

It will be noted that the various embodiments defined above (and those described below) in relation to the forming method of the invention and the associated advantages apply analogously to the customizing system of the invention.

For each step of the display method, the display system of the invention may comprise a corresponding module configured to carry out said step.

According to one embodiment, the invention is implemented by means of software and/or hardware components. In this light, the term “module” may correspond in this document to a software component, to a hardware component or to a set of hardware and software components.

A software component corresponds to one or more computer programs, to one or more sub-routines of a program, or more generally to any element of a program or software package able to implement a function or a set of functions, according to what is described below in respect of the module in question. Such a software component may be executed by a data processor of a physical entity (terminal, server, gateway, router, etc.) and is capable of accessing the hardware resources of this physical entity (memories, storage media, communication buses, input/output circuit boards, user interfaces, etc.).

In the same way, a hardware component corresponds to any element of a hardware assembly able to implement a function or a set of functions, according to what is described below in respect of the module in question. It may be a programmable hardware component or a hardware component with an integrated processor for executing software, for example an integrated circuit, a chip card, a board with memory, a circuit board for executing firmware, etc.

### BRIEF DESCRIPTION OF THE DRAWINGS

Other features and advantages of the present invention will become apparent from the description given below, with reference to the appended drawings, which illustrate examples of embodiments thereof that are completely non-limiting in nature. In the figures:

FIG. 1 is a cross-sectional view of a lenticular structure according to one particular implementation;

FIG. 2 is an exploded view schematically showing a lenticular structure according to one particular embodiment of the invention;

FIG. 3 schematically shows a 3D image comprising M images, according to one particular embodiment of the invention;

FIG. 4 schematically shows a forming system according to one particular embodiment of the invention;

FIG. 5 schematically shows, in the form of a flowchart, the steps of a forming method implemented by a customizing system, according to one particular embodiment of the invention;

FIG. 6 schematically shows a lenticular structure using which a forming method according to one particular embodiment of the invention is carried out;

FIG. 7 is a perspective view schematically showing a step of visual inspection implemented by a customizing system according to one particular embodiment of the invention;

FIG. 8 is a perspective view schematically showing a customizing step implemented by a customizing system according to one particular embodiment of the invention;

FIG. 9 is a cross-sectional view schematically showing a customizing step implemented by a customizing system according to one particular embodiment of the invention; and

FIG. 9 schematically shows the formation of a 3D image through the implementation of a forming method according to one particular embodiment of the invention; and

FIG. 10 is a cross-sectional view schematically showing one example of implementation of the customizing step, according to one particular embodiment of the invention.

### DESCRIPTION OF EMBODIMENTS

As indicated above, the invention generally relates to the formation of 3-dimensional (3D) color or grayscale images.

As is well known, the grayscale levels of an image define a value between white and black. Generally, the invention may be applied both to form a grayscale image and to form a color image. In the present disclosure, the notions of “grayscale levels” and “colors” are interchangeable with each other, depending on whether it is desired to form a grayscale or color image. The notion of color may therefore be understood in this document to also cover black, white and gray.

A 3D image within the context of the invention covers both static 3D images and 3D animations. A 3D image that is said to be static is composed of a plurality of 2D images that represent various views of one or more static objects in various viewing directions, so as to produce an impression of volume or relief when these objects are observed in various viewing directions. A 3D animation (or dynamic 3D image) is formed by a plurality of 2D images that represent various views of one or more dynamic moving objects (e.g. a running person or a bird flapping its wings), these images thus collectively forming a 3D animation effect when an observer views these images one after another in various viewing directions. In the case of a 3D animation, an impression of motion may thus be obtained in relief.

The present invention proposes to form a 3D image using a structure referred to as the “lenticular” structure, i.e. a structure equipped with lenses. More particularly, this lenticular structure comprises a carrier layer on which is formed an arrangement of sub-pixels of at least two different colors, each sub-pixel having a single color among said at least two different colors. The lenticular structure further comprises a lenticular array comprising convergent lenses placed facing the sub-pixel arrangement. Grayscale levels are further formed by laser engraving, in the carrier layer facing the sub-pixels, so as to reveal images observable in different viewing directions, these images collectively forming a 3D image. However, such a lenticular structure implies certain manufacturing constraints, which by nature limit the quality of the 3D image thus formed.

Unless otherwise indicated, elements common to a plurality of figures or analogous elements in a plurality of figures have been designated with the same reference signs and have identical or analogous characteristics, and hence these common elements have generally not been described more than once for the sake of simplicity.

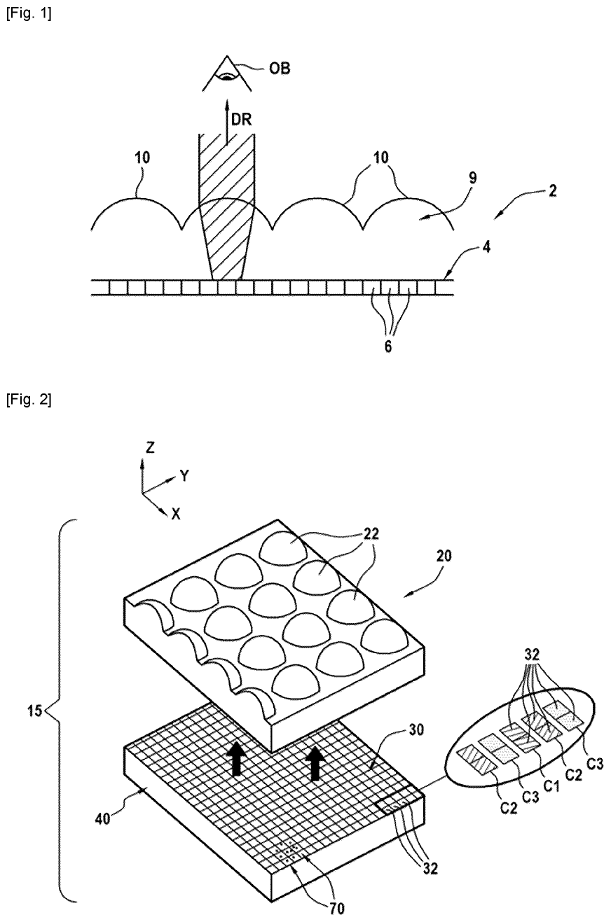

FIG. 1 shows one particular implementation of a lenticular structure 2 comprising a lenticular array 9 comprising convergent lenses 10 placed facing an arrangement 4 of color sub-pixels 6. By forming, using any technique, grayscale levels under the sub-pixels 6, it is thus possible to reveal M different images viewable by an observer OB through the lenses 10 in M different viewing directions, respectively (M being an integer at least equal to 2).

However, one problem resides in the fact that it is a priori necessary to position the sub-pixels 6 in registration with the lenses 9 in order for a 3D image of good quality to form when the lenses are looked through. Specifically, if the sub-pixels 6 are printed or formed so that they represent an interlacement of pixels of M images in very particular positions on a carrier layer, but the lenses 10 are not positioned exactly in the expected positions relative to the sub-pixels 6, such offsets may greatly degrade the quality of the final 3D image viewable by an observer OB through the lenses 10. Alignment or positioning of the lenses 10 with respect to the sub-pixels may therefore be considered a priori to be an element critical to the production of a quality 3D image.

However, precise registration of the lenses relative to the sub-pixels is in practice difficult to obtain because of tolerances or relative-positioning errors that are likely to exist by nature, this potentially degrading the quality of the 3D image thus formed considerably. The larger the screen used, the more difficult it is to position the sub-pixels in registration with the lenses. It may thus be difficult to reliably produce 3D images using this type of lenticular structure. In the absence of the invention, excessively large errors in the relative positioning of the lenses and sub-pixels may lead to the entire structure being scrapped or to the need for corrective steps that complicate the manufacturing process.

The invention therefore provides a technique allowing 3D images of good quality to be displayed using a lenticular array positioned facing a sub-pixel arrangement formed on a carrier layer, while overcoming the constraint of precise positional registration of the lenticular array with respect to the sub-pixels as explained above. The formation of 3D images is made more reliable insofar as such registration is no longer necessary by virtue of the invention, this avoiding variations in quality from one lenticular structure to another. It is therefore not necessary to correct poor positioning of the lenses relative to the sub-pixels or to scrap such display devices having excessive misalignments.

According to a forming method of the invention, offsets or variations in positioning between the sub-pixels and the lenses are compensated for by virtue in particular of a visual inspection of the lenticular structure aiming to detect the sub-pixels actually viewable through the lenses in each among M viewing directions. From the color of the sub-pixels thus detected for each viewing direction, it is thus possible to determine the grayscale levels to be generated facing the sub-pixels to form the M images composing the desired 3D image. A customization of the sub-pixel arrangement by laser engraving is then carried out to form, facing the sub-pixels, the previously determined grayscale levels so as to reveal the M images viewable through the lenticular array in the M viewing directions, respectively, these M images collectively forming the desired 3D image.

The invention also relates to a corresponding forming system, this forming system being configured to form a 3D image by implementing the forming method of the invention.

Other aspects and advantages of the present invention will become apparent from the examples of embodiment described below with reference to the drawings mentioned above.

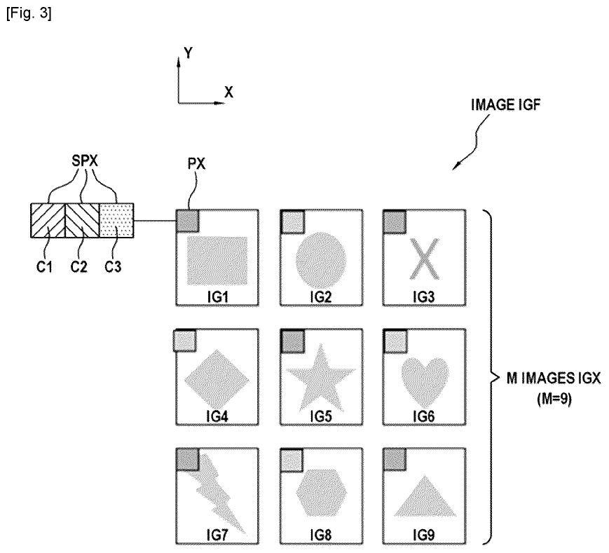

FIGS. 2 and 3 show, according to one particular embodiment, a lenticular structure 15 able to form or generate a 3D image, denoted IGF, according to the principle of the invention.

As shown, the lenticular structure comprises an arrangement 30 of sub-pixels 32 of at least two different colors, each sub-pixel 32 having a single color among these at least two different colors.

More particularly, the sub-pixels 32 may each have a single color among a basis of N different elementary colors, N being an integer at least equal to 2. It is assumed in the examples that follow that N=3, the basis of elementary colors thus being composed of 3 elementary colors denoted C1, C2 and C3. For example, the basis of elementary colors used here is the red-green-blue (RGB) basis, although other color bases are also possible. According to another example, a four-color basis of elementary colors (N=4) may be used, for example the cyan-magenta-yellow-black basis.

According to another example, the number N may be set to N=2, the elementary colors being white and black. By adapting the grayscale levels as described below, it is possible to form 3D grayscale images.

The sub-pixels 32 may be formed in various ways on the carrier layer 40 (by printing for example), the nature of these sub-pixels 32 being dependent on the formation technique adopted, as described below in particular examples. These sub-pixels 32 formed physically on the carrier layer 40 are in particular each characterized by a given color and a given lightness.

The sub-pixels 32 may thus be formed by printing, for example using an offset-printing technique. The use of a printing technique allows the sub-pixels to be formed while limiting the complexity of the manufacturing process of the lenticular structure 15.

According to another example, the arrangement 30 of sub-pixels 32 is formed by a holographic effect in a holographic metal layer (not shown) placed on the carrier layer 40. This holographic metal layer comprises a holographic structure that produces the arrangement 30 of sub-pixels 32 in the form of a hologram by diffraction, refraction and/or reflection of incident light. In particular, such a holographic metal layer may comprise diffractive nanostructures placed periodically so as to form a diffractive holographic structure that represents the arrangement 30 of sub-pixels 32.

The use of the holographic technique in particular makes it possible to obtain light 3D images that are highly saturated in color while maintaining good control of the positioning of the sub-pixels 32, this allowing 3D images of good quality to be produced. The principle of holograms is well known to the person skilled in the art. Certain elements will be recalled below for the sake of reference. Some examples of embodiment of holographic structures are for example described in document EP 2 567 270 B1.

By way of example, such a holographic metal layer comprises a relief structure (containing three-dimensional information) forming protruding segments (also called “peaks”) separated by recesses (also called “valleys”). The holographic metal layer further comprises a metal layer referred to as a “high-refractive-index layer” covering the reliefs, this metal layer having a refractive index n2 greater than the refractive index n1 of the reliefs. These reliefs form, in combination with the high-refractive-index layer, a holographic structure that produces a hologram (a holographic effect). The reliefs of the holographic structure may for example be formed by embossing a layer of stamping varnish in a known way to produce diffractive structures. The stamped surface of the reliefs thus takes the form of a periodic grating the depth of which and the period of which may be of the order of one hundred to a few hundred nanometers for example, respectively. This stamped surface is coated with the high-refractive-index metal layer, for example by means of vacuum deposition of a metal (aluminum, silver, copper, zinc sulfide, titanium oxide, etc.).

Moreover, the sub-pixels 32 may be arranged in various ways in the arrangement 30 formed on the carrier layer 40 (FIG. 2). The sub-pixels 32 are preferably distributed uniformly over the surface of the carrier layer 40, although other implementations are possible. The sub-pixels 32 may for example form parallel lines of sub-pixels, form an orthogonal matrix array, or indeed form an array of hexagons (of Bayer type), other examples of sub-pixel tiling being possible (triangular sub-pixels, etc.).

As shown in FIG. 2, the lenticular structure 15 also comprises a lenticular array 20 comprising convergent lenses 22 placed facing (i.e. opposite) the sub-pixels 32. These lenses 22 are placed so as to make incident light converge (to be brought to a focus) on the screen, or in other words so as to make the colors of the sub-pixels 32 diverge as they travel toward the exterior of the lenticular structure 15 through the lenticular array 20. It will be noted that the arrangement 30 of sub-pixels 32 is preferably positioned in (or approximately in) the focal plane of the lenses 22 of the lenticular array 20 in order to produce a 3D image of good quality. However, by virtue in particular of the forming method of the invention, as described below, it is possible not to place the sub-pixels 32 exactly in the vicinity of the focal plane of the lenses 22, while nevertheless guaranteeing the formation of a 3D image of good resolution.

The lenses 22 of the lenticular array 20 may for example be hemispherical or aspherical convergent lenses.

As described below, a forming method according to one particular embodiment of the invention may be implemented using the lenticular structure 15 shown in FIG. 2 to form a 3D image, denoted IGF (also called the final 3D image), such as shown in FIG. 3. To do this, the forming method in particular makes provision to form, by laser engraving, grayscale levels 70 in the carrier layer 40 facing (below in this example) the sub-pixels 32. Formation of these grayscale levels 70 makes it possible to customize the arrangement 30 of sub-pixels 32 so as to reveal, by way of the arrangement 30 combined with the grayscale levels 70, M images IGX viewable through the lenticular array 20 in M different viewing directions, respectively. These M 2D images thus collectively form the 3D image viewable by an observer OB by varying its viewing direction relative to the lenticular array 20 (and more generally with respect to the lenticular structure 15 in its entirety).

As illustrated below, and as described in more detail below, the aforementioned customization involves engraving carried out by means of laser radiation focused through the lenticular array on the sub-pixel arrangement 30. This laser engraving forms perforations (or holes) in the sub-pixels 32, these perforations revealing locally, through the sub-pixel arrangement 30, grayscale levels 70 caused by underlying regions of the carrier layer that are located facing these perforations.

As illustrated in FIG. 3, it is assumed in the following examples that the forming method makes it possible to form, using the lenticular structure 15, a final 3D image IGF composed of 9 images IG1-IG9 collectively denoted IGX (with M=9). Each of these images IGX is a 2D image that may be viewed through the lenses 22 in one different respective direction DR among the viewing directions DR1-DR9. In other words, each image IGX is associated with a corresponding viewing direction (or viewing orientation) DR in which (or at which) said image is viewable by an observer OB through the lenses 22. Thus, by changing viewpoint relative to the lenticular structure 15, the observer OB is able to view the 3D image IGF formed by the images IG1-IG9 via a focusing (or convergence) effect through the lenses 22. Other examples are of course possible, and a person skilled in the art will in particular be able to adapt as required the number M and the configuration of the images IGX forming the final 3D image.

Each viewing direction DR may be characterized by two respective angles (θ, φ) with respect to the normal to the lenses 22.

As shown in FIG. 3, in this example each image IGX comprises a plurality of image pixels PX, each image pixel PX comprising image sub-pixels SPX having a different color in said pixel. By way of example, it is assumed that each image pixel PX is formed from 3 image sub-pixels SPX having the elementary colors C1, C2 and C3 (in varying intensities), respectively. It will however be understood that the number of image sub-pixels SPX per image pixel PX, and the arrangement of image sub-pixels SPX and image pixels PX may be adapted according to the circumstances.

It will be noted that the sub-pixel arrangement 30 formed on the carrier layer 40 is in itself blank (independently of the grayscale levels 70), in the sense that the sub-pixels 32 do not intrinsically contain the information defining the pattern of the images IGX that it is desired to form. It is by combining this arrangement 30 of sub-pixels 32 with the grayscale levels 70 that an interlacement of the image pixels PX of the M constituent images GX of the final 3D image IGF is revealed. This interlacement viewed through the lenticular array 20 then forms the final 3D image IGF.

According to one particular example, the sub-pixels 32 are configured so that their elementary colors C1, C2 and C3 are distributed periodically in the sub-pixel arrangement 30 (the same color pattern—here “C1-C2-C3”—repeats periodically).

According to one particular example, the arrangement 30 of sub-pixels 32 is configured so as to obtain uniformity in respect of the sub-pixels 32 of the N colors (there are an equal number of sub-pixels 32 of each of the N colors). The arrangement 30 may also be configured so that, at any point therein, a sub-pixel 32 of each color among the N colors is placed at a distance less than or equal to a predetermined distance d that is chosen depending on the resolving power of the human eye. The distance d corresponds to the maximum distance at which the human eye is unable to distinguish each sub-pixel individually. It is thus possible to form 3D images of good quality.

The resolving power of the human eye is considered to be defined by 1 minute of angle (1′), i.e. 3×10⁻⁴ radians or 0.017 degrees. The distance d is preferably set so that the distance D separating the eye of an observer from the lenticular array 20 is at least equal to the distance corresponding to the resolving power of the human eye. Thus, the observer is no longer able to distinguish the color sub-pixels from one another, and it is possible to view the color corresponding to the additive synthesis of the various sub-pixels.

In practice, for the human eye not to distinguish the sub-pixels individually and for additive synthesis of the colors of the sub-pixels to be able to occur, it is necessary, for example, for the size of a complete pixel containing 3 sub-pixels to be contained in a cone of about 1 minute of angle (1′). In this regard, it is necessary to take into account the magnifying power of the lenses 22, which may be adapted according to the circumstances. In this example, it is therefore each group of 3 sub-pixels magnified by a lens 22 that must be contained in the cone of 1 minute of angle. For example, for an observation at a distance D=0.5 meters from the lenticular array 20, the lenticular structure 15 may for example be configured to respect the following expression:

$$\frac{{d}^{′} / 2}{D} < tan {1}^{′} \qquad [ Math . 1 ]$$

i.e. d′<291 μm, where d′ is the so-called “apparent” size of each sub-pixel 32, i.e. its size magnified through a lens 22. Therefore, the apparent sub-pixels (as they appear magnified through the lenses) must each be less than 97 μm in size (side length). According to another example where D=0.3 meters, the apparent sub-pixels must be smaller than 58 μm.

However, various variants are possible in particular in terms of the arrangement and shape of the sub-pixels 30 formed on the carrier layer 40, and of their intrinsic color and lightness.

As described below, precise determination of the grayscale levels to be formed in the carrier layer 40 facing each sub-pixel 32 of the arrangement 30 is necessary to take into account tolerances or errors in the relative positioning of the lenses 22 with respect to the sub-pixels 32.

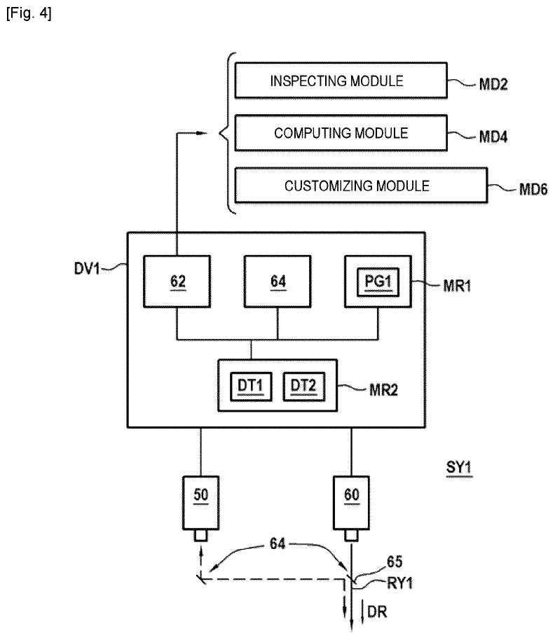

FIG. 4 shows, according to one particular example, a forming system SY1 configured to form a 3D image using a lenticular structure 15 such as described above, by implementing the forming method of the invention.

More particularly, the forming system SY1 comprises a control unit DV1, an image-capturing apparatus 50 and a laser device 60.

The image-capturing apparatus 50 is configured, under control by the control unit DV1, to perform a visual inspection (or visual observation) of the lenticular structure 15 prior to the formation of grayscale levels. This image-capturing apparatus 50 makes it possible to view the sub-pixels 32 through the lenses 22 in the various viewing directions DR1-DR9. The control unit DV1 is capable of using the image-capturing apparatus 50 to detect sub-pixels viewable through the lenticular array 20 for each of the M viewing directions DR1-DR9. To this end, the image-capturing apparatus 50 may comprise one or more cameras, or any other suitable equipment allowing such a visual inspection (one or more CCD sensors for example).

The laser device 60 is configured to project laser radiation RY1 through the lenticular array 20 onto the arrangement 30 of sub-pixels 32 under control by the control unit DV1. As described below, this laser radiation RY1 makes it possible to produce perforations in the arrangement 30 of sub-pixels 32 so as to reveal grayscale levels, facing the sub-pixels 32, caused by underlying regions of the carrier layer 40 of the lenticular structure 15 (FIG. 2). To do this, the laser device 60 is capable of projecting the laser radiation RY1 through the lenticular array 20 in each of the viewing directions DR.

In one particular example shown in FIG. 4, the laser device 60 is placed in the optical train of the image-capturing apparatus 50, this allowing the laser device 60 to project the laser radiation RY1 exactly in the same direction (or orientation) as the direction of the image-capturing apparatus 50 relative to the lenticular structure 15. To this end, the customizing system SY1 for example comprises a set 64 of mirrors, including a semi-transparent mirror 65 placed facing the laser device 60 and oriented so as to transmit by reflection to the image-capturing apparatus 50 at least some of the light coming from the lenticular structure 15. This particular configuration of the image-capturing apparatus 50 and of the laser device 60 makes it possible to ensure good positional accuracy when customizing the arrangement 30 of sub-pixels 32 by laser engraving.

The forming system SY1 may for example comprise a mechanism configured to simultaneously vary the relative position of an assembly comprising the image-capturing apparatus 50 and the laser device 60 with respect to the lenticular structure 15. This assembly in particular makes it possible to orient the image-capturing apparatus 50 and the laser device RY1 in each of the viewing directions DR that the eye of an observer OB must adopt to observe the M images IGX once the forming method has ended.

The central unit DV1 comprises, in this example, a processor (or controller) 62, a volatile memory 64 (RAM), a non-volatile memory MR1, a rewritable non-volatile memory MR2.

The memory MR1 is a rewritable non-volatile memory or a read-only memory (ROM), this memory forming a storage medium (or data medium) according to one particular embodiment, being readable by the control unit DV1, and storing a first computer program PG1 according to one particular embodiment. This computer program PG1 comprises instructions for the execution of the steps of a forming method according to one particular embodiment, as described below.

The rewritable non-volatile memory MR2 is able to store, where appropriate, inspection data DT1 and image data DT2. The inspection data DT1 may be generated by the control unit DV1 during a visual inspection of the lenticular structure 15, these inspection data characterizing sub-pixels 32 detected by means of the image-capturing apparatus 50 through the lenticular array 20 in the various viewing directions DR. The image data DT2 are representative of the M images IGX forming the final 3D image IGF that it is desired to form using the lenticular array 15. The nature and functions of the data DT1 and DT2 will be described in more detail below.

The way in which the image data DT2 are obtained may vary depending on the case, these data in particular possibly being received from an exterior source, or being stored beforehand in the memory MR2 of the control unit DV1.

The processor 62 uses the volatile memory 62 to carry out the various operations and functions necessary to the operation of the control unit DV1, including to execute the computer program PG1 during the implementation of the forming method of the invention. The control unit DV1 in particular drives the image-capturing apparatus 50 and the laser device 60 to carry out the forming method according to the invention.

As shown in FIG. 4, according to one particular example, the processor 62 driven by the computer program PG1 here implements a certain number of modules, namely: an inspecting module MD2, a computing module MD4 and a control module MD6.

More precisely, the inspecting module MD2 is configured to perform a visual inspection of the lenticular structure 15 (FIG. 2) by viewing the arrangement 30 of sub-pixels 32 through the lenticular array 20 by means of the image-capturing apparatus 50, said visual inspection comprising the following steps for each among the M different viewing directions DR relative to the lenticular array 20 (M being an integer at least equal to 2):
a1) positioning the image-capturing apparatus in the viewing direction DR;
a2) detecting sub-pixels 32 viewable through the lenses 22 in said viewing direction DR.

The computing unit MD4 is configured to determine, from the color of the sub-pixels detected in the visual inspection for each viewing direction DR, grayscale levels 70 to be generated to reveal, by way of the arrangement 30 of sub-pixels 32, the M images IGX viewable through the lenticular array 20 in the M viewing directions DR, respectively.

The customizing unit MD6 is configured to customize the arrangement 30 of sub-pixels 32 by forming grayscale levels 70 facing the sub-pixels in the carrier layer 40 by focus of laser radiation RY1 through the lenses 22 so as to reveal the M images IG1-IGX9 viewable through the lenticular array 20 in the M viewing directions DR1-DR9, respectively, said M images IG1-IGX9 collectively forming the 3D image IGF.

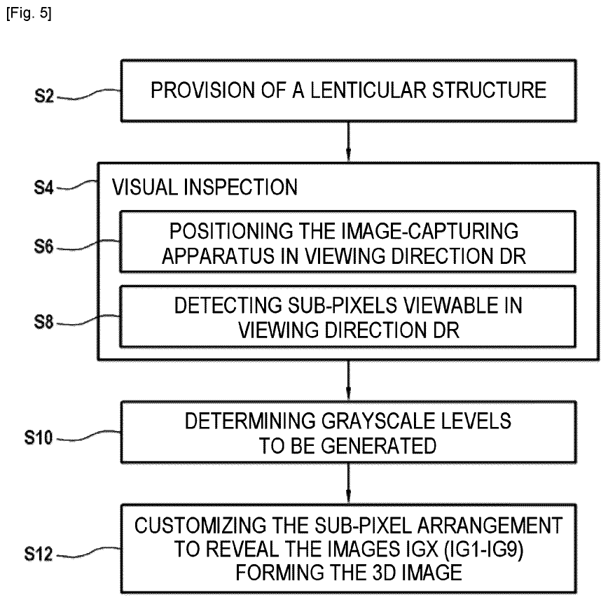

The configuration and operation of the modules MD2-MD6 of the control unit DV1 will become more clearly apparent from the examples of embodiment described below with reference to FIGS. 5-10.

The forming system SY1 described above with reference to FIG. 4, and the modules shown in FIG. 5, are merely examples of embodiment, other implementations being possible in the context of the invention. Those skilled in the art will in particular understand that certain elements of the forming system SY1 are described here merely to facilitate comprehension of the invention, these elements not being necessary to implement the invention.

With reference to FIGS. 5-9, the forming method of the invention implemented by the forming system SY1 will now be described according to one particular embodiment. For this purpose, the control unit DV1 executes the computer program PG1.

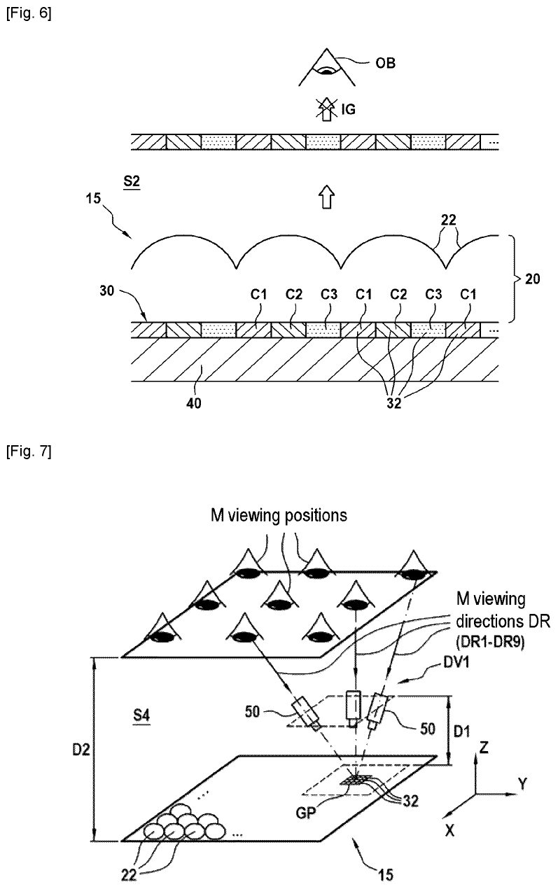

More precisely, it is assumed that the lenticular structure 15 shown in FIG. 6 and such as described above with reference to FIG. 2 is available or has been formed (S2, FIG. 5). This lenticular structure 15 is in an initial state (blank) prior to the future customizing step. In its initial state, the lenticular structure 15 is therefore devoid of grayscale levels facing the sub-pixels 32. At this stage, an observer OB therefore sees through the lenticular array 20 only the blank arrangement of sub-pixels 32.

The forming system SY1 now implements steps S4-S12 (FIG. 5) of the forming method so as to form, using the lenticular structure 15 in its initial state illustrated in FIG. 6, a final 3D image IGF such as described above with reference to FIG. 3.

As already described, offsets or tolerances in the positioning of the lenses 22 relative to the sub-pixels 32 are by nature liable to occur and therefore impact the quality of the final 3D image. To overcome this problem, the forming method in particular comprises a step S4 of visual inspection and a step S10 of determining the grayscale levels to be formed to reveal the final 3D image IGF.

Thus, during an inspecting step S4, the customizing system SY1 performs a visual inspection (or visual observation) of the lenticular structure 15 by means of the image-capturing apparatus 50. This inspecting step S4 comprises the steps S6 and S8 described below for each among the M different directions DR1-DR9 relative to the lenticular array 20, M being an integer at least equal to 2 (M=9 in the present case). In other words, an inspection procedure comprising steps S6 and S8 is executed for each of the viewing directions DR1-DR9 in this example. The various iterations S6-S8 may be carried out simultaneously, in groups of viewing directions DR or one viewing direction DR after another according to the circumstances, as described below.

The procedure S6-S8 is described below, with reference to FIG. 7, for one of the viewing directions DR and applies in the same way to each of the viewing directions DR. During the positioning step S6, the image-capturing apparatus 50 is positioned in the viewing direction DR in question (DR1 for example). The customizing system SY1 then views, by means of the image-capturing apparatus 50, the arrangement of sub-pixels 32 through the lenticular array 20. During a detecting step S8, the customizing system SY1 then detects sub-pixels 32—called useful sub-pixels—which are viewable (or visible) through the lenses 22 according to the viewing direction DR in question.

Depending on the configuration of the lenticular structure 15 and its position relative to the image-capturing apparatus 50, the customizing system SY1 is able to view certain sub-pixels 32 while others are not visible (masked). It is assumed here that the customizing system thus detects a group GP of viewable sub-pixels 32 in each of the M viewing directions DR, respectively. It will be noted that certain sub-pixels 32 detected as visible by the customizing system SY1 for a viewing direction DR may be visible only partially, typically if only part thereof is visible through the lenses 22.

The group GP detected in S8 thus comprises the useful sub-pixels 32, which are distributed facing the various lenses 22 during detecting step S6 for the viewing direction DR in question. The sub-pixels 32 that are masked are not included in group GP for the viewing direction DR in question because they are unable to be seen by the image-capturing apparatus 50 in the viewing direction DR in question.

During the visual inspection S4, the image-capturing apparatus 50 may thus effect an angular and/or translational relative movement with respect to the lenticular array 20 to position itself, in S6, in each of the M viewing directions DR, so as to carry out detecting step S8 for each of the M viewing directions DR. The position of the image-capturing apparatus 50 may for example be defined by spherical coordinates (r,θ,φ).

This or these relative movements may be carried out in various ways, under control by the control unit DV1, for example by moving the image-capturing apparatus 50 and/or the lenticular structure 15. According to one particular example, the lenticular structure 15 rotates so that the image-capturing apparatus 50 may observe the sub-pixels 32 in each of the M viewing directions DR. The image-capturing apparatus 50 may also be rotated and/or translated to scan the surface of the arrangement 30 of sub-pixels 32 in all the viewing directions DR, so as to be able to perform the detecting step S8 that follows for each viewing direction DR.

It will be noted that the image-capturing apparatus 50 may optionally be capable of viewing the sub-pixels 32 through the lenses 22 simultaneously in a plurality of viewing directions DR without any movement being necessary. The image-capturing apparatus 50 may then perform steps S6 and S8 for all the viewing directions DR while making a number of movements lower than the number M of viewing directions DR. According to one particular example, the image-capturing apparatus 50 is capable of viewing the arrangement 30 of sub-pixels 32 through the lenses 22 simultaneously in all the M viewing directions DR so that no movement is necessary, this in particular being possible if the size of the arrangement 30 of sub-pixels 32 is sufficiently limited to allow the image-capturing apparatus 50 (a camera for example) to cover the entire area of said arrangement 30.

To carry out the steps S6-S8, the image-capturing apparatus 50 may also comprise a plurality of cameras oriented in various directions so as to be able to view, without making any movement, the sub-pixels 32 through the lenses 22 in all the viewing directions DR. According to one particular example, the image-capturing apparatus 50 comprises a panel of M (or more) fixed cameras that view the sub-pixels 32.

In this example the control unit DV1 determines, during the visual inspection S4, characteristics of the useful sub-pixels 32 that are viewable in each of the viewing directions DR1-DR9. More particularly, the control unit DV1 generates (S8) in this example inspection data DT1 comprising the characteristics of the sub-pixels 32 thus detected. These data DT1 therefore characterize the sub-pixels 32 detected in S8 through the lenticular array 20 for each of the M viewing directions DR1-DR9. These inspection data are, for example, stored in the memory MR2 of the control unit DV1 (FIG. 4).

The characteristics comprised in the inspection data DT1 identify, for each viewing direction DR, the useful sub-pixels 32 and their respective color (among C1, C2 and C3 in this example), optionally in association with other information such as lightness. The lightness level of the useful sub-pixels may allow the control unit DV1 to determine whether a useful sub-pixel 32 is completely or partially viewable through the lenticular array 20 for a given viewing direction DR.

A sub-pixel 32 is partially viewable if only part of this sub-pixel is visible through a lens 22 for the given viewing direction DR in detecting step S8. A sub-pixel 32 is for example viewable only partially through a lens 22 for a given viewing direction DR if it is located on the periphery of the group GP of viewable sub-pixels 32 so that only part of this peripheral sub-pixel is visible by focusing through the lens 32 located facing.

According to one particular example, the inspection data DT1 generated in S8 may in particular be representative of a degree of visibility of the sub-pixels 32 detected in S8 through the lenses 22 of the lenticular array 20 in each viewing direction DR. The control unit DV1 may for example determine that a sub-pixel 32 is useful, i.e. viewable through the lenticular array 20, for a given viewing direction DR if its lightness is at least equal to a predefined threshold value. This predefined threshold value may be set by a person skilled in the art and may in particular be equal to a ratio of a maximum expected lightness value for the conditions of the case in question.

In a computing step S10 (FIG. 5), the control unit DV1 determines, from the color of the sub-pixels detected in S8 for each viewing direction DR, grayscale levels 70 to be generated to reveal, by way of the arrangement 30 of sub-pixels 32, the M images IGX (FIG. 3) viewable through the lenticular array 20 in the M viewing directions DR1-DR9, respectively. To do this, the control unit DV1 performs a computation that makes it possible to determine the configuration (position, size, etc.) of the grayscale levels 70 to be formed, depending on the sub-pixels 32 actually viewable for each viewing direction DR and depending on the corresponding images IGX that it is desired to form for each viewing direction DR.

In this example, the control unit DV1 determines in S10 the grayscale levels 70 from the inspection data DT1 generated during the visual inspection S4 and from image data DT2 representative of the M images IGX forming the final 3D image IGF that it is desired to form. As already indicated, the control unit DV1 is able to obtain, receive or determine these image data DT2 in any appropriate manner.

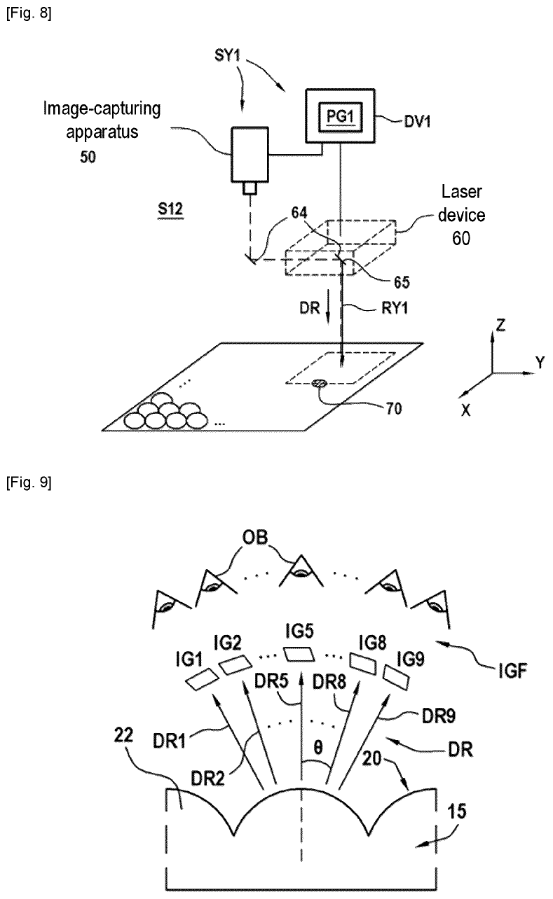

During a customizing step S12 (FIG. 5) illustrated in FIG. 8, the customizing system SY1 carries out a customization of the arrangement 30 of sub-pixels 32, during which the grayscale levels 70 determined in S10 are engraved facing the sub-pixels 32 by focus of laser radiation RY1 through the lenticular array 20 so as to reveal, by way of the arrangement 30 of sub-pixels 32 combined with the grayscale levels 70, the M images IGX (IG1-IG9) viewable through the lenticular array 20 in the M viewing directions DR (DR1-DR9), respectively, these M images IGX collectively forming the 3D image IGF. To do this, the laser device 60 projects, under control by the control unit DV1, the laser radiation RY1 through the lenses 22 at various positions in the sub-pixel arrangement 30. Grayscale levels 70 are thus formed in the arrangement 30 of sub-pixels 32 depending on the energy delivered by the laser device 60 at each point.

In the customizing step S12, the laser radiation RY1 may be projected by the laser device 50 from a distance D1 with respect to the lenticular array 20 that is less than the distance D2 by which the eye of the observer OB is supposed to be separated from the lenticular array 20 when the observer views the final image 3F IGF (as shown in FIG. 7).

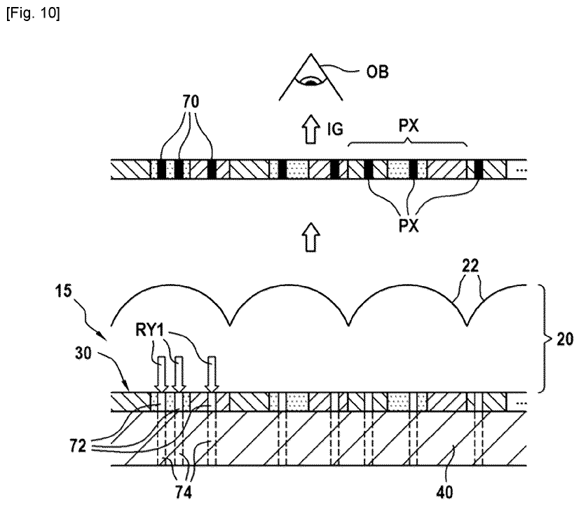

As already indicated, the arrangement 30 of sub-pixels 32 is in itself blank, in the sense that the sub-pixels 32 do not intrinsically contain the information defining the pattern of the M images IGX1-IGX9 that it is desired to form. It is the combination of this arrangement 30 of sub-pixels with the grayscale levels 70 that reveals an interlacement of the image pixels PX of the M constituent images IGX of the final 3D image IGF. As shown in FIG. 9, this interlacement thus forms or generates the M images IGX viewable through the lenticular array 20 in the M viewing directions DR1-DR9, respectively.

In the customizing step S12, the laser radiation RY is projected through the lenses 22 in the M viewing directions DR so that an observer OB may view through the lenses 22 each of the IGX images by adopting the corresponding viewing direction DR.

According to one particular example, the M images IGX represent various views of the same static object, these various views respectively being viewable in the adopted viewing directions DR through the lenticular array 20, so as to produce a 3D effect.

According to one particular example, the M images IGX represent various views of the same moving object, these various views being viewable in the adopted viewing directions DR through the lenticular array so as to produce a 3D animation.

The customizing system SY1 shown in FIGS. 4 and 8 is advantageous in that the image-capturing apparatus 50 is placed in the same optical train as the laser device 60 (the image-capturing apparatus 50 thus views the point of the arrangement 30 of sub-pixels to which the laser device 60 points at the same time). Thus, it is possible to form the grayscale levels 70 with a good positional accuracy.

Various ways of implementing step S12 (FIG. 5) of customizing the arrangement 30 of sub-pixels may be envisioned.

In one example shown in FIG. 10, in the customizing step S12, perforations (or holes) 72 are produced in the arrangement 30 of sub-pixels 32 by focus of the laser radiation RY1 through the lenticular array 20 so as to reveal locally, through the sub-pixel arrangement 30, grayscale levels 70 in the sub-pixels 32 caused by underlying regions 74 of the carrier layer 40 located facing the perforations 72.

As already indicated, the laser radiation RY is projected in customizing step S12, through the lenses 22 in the M viewing directions DR in order to adapt the position at which the laser radiation RY is focused on the arrangement 30 of sub-pixels 32. It is thus possible to precisely control the position at which the perforations 72 are produced. In particular, M groups of perforations 74 may be formed in the arrangement 30 of sub-pixels 32 by projecting the laser radiation RY1 in the M viewing directions DR, respectively. These M groups then form the grayscale levels 70, to reveal the M images IGX viewable in the M viewing directions DR, respectively.

The grayscale levels 70 formed in the sub-pixels 32 are generally regions of colorimetric shade the appearance of which may vary depending on the nature, and in particular color, of the underlying regions 74 of the carrier layer 40 revealed by the perforations 72. Thus, the grayscale levels 70 may for example be dark if the underlying regions 74 of the carrier layer 40 are opaque or non-reflective at least in the visible spectrum.

According to one example, the carrier layer 40 is opaque (or non-reflective) at least in the visible spectrum and the perforations 72 formed in the laser-based customizing step S12 reveal locally, through the arrangement 30 of sub-pixels 32, dark underlying regions 74 of the carrier layer 40, said dark underlying regions being located facing the perforations 72 and then forming all or some of the grayscale levels 70 facing the sub-pixels 32.

In the case where it is opaque, the carrier layer 40 absorbs at least the wavelengths of the visible spectrum. It is for example a dark layer (one black in color for example). In the present disclosure, the visible spectrum is considered to lie between approximately 400 and 800 nanometers (nm), or more precisely between 380 and 780 nm in free space.

According to one particular example, the carrier layer 40 comprises an opaque black surface facing the arrangement 30 of sub-pixels 32 and/or comprises opacifying black (or dark) pigments in its bulk. The carrier layer 40 may in particular comprise a black ink, or even a material colored in its bulk by black or opacifying (or dark) pigments.

An observer OB may thus view in reflection the various constituent images IG1-IG9 of the 3D image IGF by varying her or his viewing direction among the M viewing directions DR1-DR9.

The grayscale levels 70 formed in the laser-based customizing step S12 may also be light if the underlying regions 70 of the carrier layer 40 are transparent with respect to at least the visible spectrum. According to one particular example, the carrier layer 40 is transparent at least in the visible spectrum and the perforations 72 reveal locally, through the arrangement 30 sub-pixels 32, light underlying regions 74 of the carrier layer 40, said light underlying regions 74 being located facing the perforations 72 when incident light in the visible spectrum is projected through the carrier layer 40, and then forming all or some of the grayscale levels 70 facing the sub-pixels 32.

In this case, an observer OB is able to view, through transmission of light projected from the back side of the lenticular structure 15, the various constituent images IG1-IG9 of the 3D image IGF by varying her or his viewing direction among the M viewing directions DR1-DR9.

According to one particular example, the carrier layer 40 is reactive (or sensitive) at least in the UV (ultraviolet) spectrum, this for example being achieved by printing, on the carrier layer 40, a UV-reactive fluorescent ink. Thus, in one particular example, the carrier layer 40 comprises a UV-sensitive ink, so that the final 3D image IGF is visible when the carrier layer 40 is exposed to UV, the ink revealed through the perforations 72 then forming all or some of the grayscale levels 70 facing the sub-pixels 32.

More generally, whatever the nature of the carrier layer 40 (opaque, transparent or fluorescent), the perforations 72 may be arranged so as to selectively modify, with respect to one another, the colorimetric contribution of the sub-pixels 32 in the arrangement 30.

As already indicated, the arrangement 30 of sub-pixels 32 may be formed by printing on the carrier layer 40. As a variant, the arrangement 30 of sub-pixels 32 is formed by a holographic effect by means of a holographic metal layer placed on the carrier layer 40. In the latter case, the laser perforation in customizing step S12 leads to a local destruction of the geometry of the holographic structure, and more particularly of the reliefs and/or of the metal layer covering these reliefs. The holographic effect is eliminated, or reduced, in the perforated regions of the holographic structure, this making it possible to decrease (or even completely eliminate) the relative color contribution of the perforated sub-pixels 32 while revealing underlying regions 74 that modify the colorimetric contribution of the sub-pixels in the interlacement of pixels and therefore in the final image 3G IGF.

The invention makes it possible to overcome the constraint of precise positional registration of the lenses with respect to the sub-pixels, and thus makes it possible to produce 3D images of good quality reliably insofar as such registration is not required. Any offsets of the sub-pixels with respect to the lenses are compensated for by virtue of the visual inspection, which allows the useful sub-pixels that are actually viewable through the lenses for each viewing direction to be determined. The grayscale levels may thus be formed by laser engraving taking into account the actual relative position of the lenses with respect to the sub-pixels.

3D images of good resolution may thus be obtained, including with arrangements of sub-pixels of relatively large size, where offsets and errors in relative positioning are more difficult to avoid. It is in particular possible to use the lenticular structure of the invention to generate 3D images permanently, for example independently of any power supply (contrary to a screen requiring a supply of electrical power to display an image, the sub-pixels in the invention are permanently formed on the carrier layer physically).

The invention therefore simplifies the manufacturing process of the lenticular structures used to form 3D images, insofar as it is not necessary to precisely control the relative position of the lenses or to verify said relative position to as high a level of precision during manufacturing. Similarly, it makes it possible to avoid scrapping certain lenticular structures during production or even to avoid implementation of corrective production steps to structurally correct these positioning errors.

The invention is in particular applicable to the formation of 3D images of any kind, in various contexts, for example formation of a 3D image in a security document (in particular in an identity document such as an identity card, a passport, etc.) or even display of advertising images in a public space, on billboards for example.

Those skilled in the art will understand that the embodiments and variants described above are merely non-limiting examples of implementations of the invention. In particular, a person skilled in the art will be able to envisage any adaptation or combination of the embodiments and variants described above, in order to meet a particular need according to the claims presented below.

1. A method for forming a 3D image, using a lenticular structure comprising:
a carrier layer on which is formed an arrangement of sub-pixels of at least two different colors, each sub-pixel having a single color among said at least two different colors; and
a lenticular array comprising convergent lenses placed facing the sub-pixel arrangement;
the method comprising the following steps:
a) performing visual inspection of the lenticular structure, by means of an image-capturing apparatus, said visual inspection comprising the following steps for each among M different viewing directions relative to the lenticular array, M being an integer at least equal to 2:
a1) positioning the image-capturing apparatus in the viewing direction;
a2) detecting sub-pixels viewable through the lenses in said viewing direction;
b) determining, based on the color of the sub-pixels detected in a2) for each viewing direction, grayscale levels to be generated to reveal, by way of the arrangement of sub-pixels, M images viewable through the lenticular array in the M viewing directions, respectively; and
c) customizing the sub-pixel arrangement, during which the grayscale levels determined in b) are engraved facing the sub-pixels in the carrier layer by focus of laser radiation through the lenticular array so as to reveal, by way of the sub-pixel arrangement combined with the grayscale levels, the M images viewable through the lenticular array in the M viewing directions, respectively, said M images collectively forming the 3D image.

2. The method as claimed in claim 1, said method being implemented by a customizing system comprising the image-capturing apparatus and a laser device placed in the optical train of the image-capturing apparatus, the laser device projecting the laser radiation in customizing step c) in each viewing direction adopted by the image-capturing apparatus in positioning step a1).

3. The method as claimed in claim 1, wherein the grayscale levels engraved in customizing step c) intrinsically form with the sub-pixel arrangement an interlacement of image pixels of the M images viewable through the lenticular array by varying the viewing direction among the M viewing directions.

4. The method as claimed in claim 1, wherein the M images represent:
various views of the same static object, these various views respectively being viewable in space in the adopted viewing directions through the lenticular array so as to produce a 3D effect; or
various views of the same moving object, the various views being viewable in the adopted viewing directions through the lenticular array so as to produce a 3D animation.

5. The method as claimed in claim 1, wherein the sub-pixels are configured so that their respective colors, among said at least two different colors, are periodically distributed in the sub-pixel arrangement.

6. The method as claimed in claim 1, wherein the sub-pixel arrangement is formed by either one of the following steps:
d) printing on the carrier; and
e) forming a holographic metal layer.

7. The method as claimed in claim 1, wherein the lenses of the lenticular array are hemispherical or aspherical convergent lenses.

8. The method as claimed in claim 1, the sub-pixel arrangement being positioned approximately in the focal plane of the lenses of the lenticular array.

9. The method as claimed in claim 1, wherein, during visual inspection a), the image-capturing apparatus effects an angular and/or translational relative movement to position itself, in a1), in each of the M viewing directions, so as to carry out detecting step a2) for each viewing direction.

10. The method as claimed in claim 1, wherein the method comprises storing, in a memory of the customizing system inspection data characterizing the sub-pixels detected in a through the lenticular array for each of the M viewing directions,
said determining step b) being carried out based on the inspection data and on image data representative of the M images forming the 3D image.

11. The method as claimed in claim 1, wherein, in the customizing step, perforations are produced in the sub-pixel arrangement by said focus of the laser radiation so as to reveal locally, through the sub-pixel arrangement, grayscale levels in the sub-pixels caused by underlying regions of the carrier layer located facing the perforations.

12. The method as claimed in claim 11, the carrier layer being opaque at least in the visible spectrum,
wherein the perforations formed in the customizing step reveal locally, through the sub-pixel arrangement, dark underlying regions of the carrier layer, said dark underlying regions being located facing the perforations and forming all or some of the grayscale levels facing the sub-pixels.

13. The method as claimed in claim 11, the carrier layer comprising an ultraviolet-sensitive ink so that the 3D image is visible when said carrier layer is exposed to ultraviolet, the ink revealed through the perforations forming all or some of the grayscale levels facing the sub-pixels.

14. The method as claimed in claim 11, the carrier layer being transparent at least in the visible spectrum, wherein the perforations reveal locally, through the sub-pixel arrangement, light underlying regions of the carrier layer, said light underlying regions being located facing the perforations when incident light in the visible spectrum is projected through the carrier layer, and forming all or some of the grayscale levels facing the sub-pixels.

15. A customizing system for forming a 3D image using a lenticular structure comprising:
a carrier layer on which is formed an arrangement of a plurality of sub-pixels of at least two different colors, each sub-pixel having a single color among said at least two different colors; and
a lenticular array comprising convergent lenses placed facing the sub-pixel arrangement;
the customizing system comprising:
an inspecting unit configured to perform a visual inspection of the lenticular structure by viewing the sub-pixel arrangement through the lenticular array by means of an image-capturing apparatus, said visual inspection comprising the following steps for each among M different viewing directions relative to the lenticular array, M being an integer at least equal to 2:
a1) positioning of the image-capturing apparatus in the viewing direction;
a2) detecting sub-pixels viewable through the lenses in said viewing direction;
a computing unit configured to determine, from the color of the sub-pixels detected in a2) for each viewing direction, grayscale levels to be generated to reveal, by way of the sub-pixel arrangement, M images viewable through the lenticular array in the M viewing directions, respectively; and
a customizing unit configured to customize the sub-pixel arrangement by forming grayscale levels facing the sub-pixels in the carrier layer by focus of laser radiation through the lenses so as to reveal the M images viewable through the lenticular array in the M viewing directions, respectively, said M images collectively forming the 3D image.
